(19) United States
(12) Patent Application Publication
(10) Pub. No.: US 2007/0299637 A1
(43) Pub. Date: Dec. 27, 2007

(54) Design supporting apparatus, design supporting method and computer-readable recording medium recording design supporting program

(75) Inventors: Tsukasa Tenma, Kawasaki (JP); Makoto Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/545,557

(22) Filed: Oct. 11, 2006

(30) Foreign Application Priority Data
Jun. 27, 2006 (JP) 2006-176740

(51) Int. Cl. G06F 17/50

(52) U.S. Cl. 703/1

(57) ABSTRACT

The present invention relates to a design supporting apparatus for enabling an operator to recognize a density of a structure at a glance for a verification of the structure density, thereby achieving efficient and accurate implementation of the density verification. The design supporting apparatus comprises a spatial shape calculating unit for calculating a spatial shape within a predetermined area of a structure on the basis of three-dimensional design data on the structure, a structural shape calculating unit for calculating a structural shape within the predetermined area of the structure on the basis of the three-dimensional design data, a density calculating unit for calculating a structural density or spatial density within the predetermined area of the structure on the basis of the spatial shape and the structural shape, and a display control unit for making a display unit display the structural density or spatial density calculated by the density calculating unit.

### BACKGROUND OF THE INVENTION

1) Field of the Invention

The present invention relates to a technique for effectively utilizing three-dimensional design data on a structure, and more particularly to a technique of verifying a density within a predetermined area of the structure on the basis of the three-dimensional design data and a technique of making a study of layout of desired parts through the use of the three-dimensional design data.

2) Description of the Related Art

In recent years, a three-dimensional design using a design supporting (aid) apparatus such as CAD (Computer Aided Design) has been increasingly employed for design/development of a structure such as apparatus.

In addition, with respect to an apparatus designed through the use of the CAD, there has frequently been verified the density such as packaging density within a predetermined area of the apparatus. For example, a verification is sometimes made on a density of a component of an apparatus (structure density; hereinafter referred to as “packaging density”) within a predetermined area of a structure or on a density of clearance gap (space; hereinafter referred to as “space density”) within the area thereof.

So far, for example, in a case in which a verification is made on a density of an electronic device including a printed-circuit board mounting a plurality of parts within a predetermined area, a reverse model of the device designed through the use of the CAD or a cross-sectional illustration thereof is created by using three-dimensional CAD data (hereinafter referred to as “three-dimensional design data) of the device and, for example, the area of the two-dimensional clearance (space) within the predetermined area is calculated on the basis of the reverse model or the cross-sectional illustration so as to express a partial density.

In this case, the reverse model of the device signifies a spatial shape appearing after a shape of parts constituting the device is removed (excluded) from the maximum external shape (configuration) of the device.

For example, a reverse model of a structure 1 made as shown in FIG. 25 becomes a spatial shape (reverse model) 1x shown in FIGS. 26(a) and 26(b). In this case, the structure 1 has a hollow rectangular parallelepiped shape in which a printed-circuit board 3 is put on an upper surface of a lower component 2 and parts (packaging parts) 4a to 4l are mounted on the printed-circuit board 3 and an upper component 5 having a lid-like shape is joined to the lower component 2 so as to cover the printed-circuit board 3.

Moreover, FIG. 26(a) is a perspective view showing the spatial shape 1x when the structure 1 is viewed from above in a state shown in FIG. 25 and, in FIG. 26(a), a cavity-like portion having a rectangular parallelepiped shape and designated at reference numeral 4l′ corresponds to a part 4l.

Still moreover, FIG. 26(b) is a perspective view showing the spatial shape 1x when the structure 1 is viewed from below in a state shown in FIG. 25, i.e., a perspective illustration when the spatial shape 1x shown in FIG. 26(a) is viewed from the rear side and, in FIG. 26(b), cavity-like portions designated at reference numerals 4a′ to 4l′ correspond to parts 4a to 4l, respectively.

That is, according to a conventional technique, in the case of a verification of a packaging density of the structure 1, an operator creates a plurality of two-dimensional cross sections, each being on object of verification, on the basis of the reverse model 1x shown in FIGS. 26(a) and 26(b) so as to seize a density by partially expressing the verification object portions with a plurality of two-dimensional cross sections.

In addition, as the conventional technique utilizing a spatial model, there has been known a technique which is for promptly providing height restriction information on small-sized electronic parts made by packaging a plurality of parts in a printed-circuit board and which is designed to convert three-dimensional height restriction information into two-dimensional information in a manner such that a spatial model is sliced at a predetermined interval to express height restriction by a contour line on the basis of the sliced outer circumference (for example, see Japanese Patent Laid-Open No. 2000-148823 (Patent Document 1)).

There is a problem which arises with the above-mentioned conventional technique, however, in that, as a structure becomes more complicated, more difficulty is experienced in partially expressing (seizing) the place and degree of packaging through the use of a two-dimensional cross section, which can make it difficult to carry out accurate density verification.

In addition, it is difficult to not only easily express the entire structure by use of a two-dimensional cross section and but also enable an operator to recognize a clearance gap of a structure at a glance and even seize an area having much space.

That is, for seizing the packaging density (three-dimensional clearance gap (volume/capacity of a space)) of the entire structure through the use of two-dimensional cross-sectional illustrations, there is a need to use a large number of two-dimensional cross-sectional illustrations, which requires extremely long time.

And using a large number of two-dimensional cross-sectional illustrations, an operator cannot recognize a clearance gap in the entire structure at a glance, which makes it difficult to fulfill a judgment on an area having much space.

Moreover, according to the above-mentioned conventional technique, a comparison in density among a plurality of structures requires the confirmation of a plurality of two-dimensional cross-sectional illustrations with respect to each of the structures, which makes it difficult for the operator to recognize the differences in density among the plurality of structures at a glance.

### SUMMARY OF THE INVENTION

The present invention has been developed with a view to eliminating the above-mentioned problems, and it is therefore an object of the invention to enable an operator to recognize a density of a structure at a glance for a verification of the structure density, thereby achieving efficient and accurate implementation of the density verification.

For this purpose, in accordance with the present invention, there is provided a design supporting apparatus comprising a spatial shape calculating unit for calculating a spatial shape within a predetermined area of a structure on the basis of three-dimensional design data on the structure, a structural shape calculating unit for calculating a structural shape within the predetermined area of the structure on the basis of the three-dimensional design data, a density calculating unit for calculating a structural density or spatial density within the predetermined area of the structure on the basis of the spatial shape calculated by the spatial shape calculating unit and the structural shape calculated by the structural shape calculating unit, and a display control unit for making a display unit display the structural density or spatial density calculated by the density calculating unit.

Preferably, the design supporting apparatus further comprises a calculation direction setting unit for setting a calculation direction of the structural density or spatial density to be calculated by the density calculating unit, the density calculating unit calculating the structural density or spatial density on the basis of the calculation direction set by the calculation direction setting unit.

In addition, preferably, the design supporting apparatus further comprises a calculation area setting unit for setting one or a plurality of calculation areas as the predetermined area of the structure so that the density calculating unit calculates the structural density or spatial density of the calculation area set by the calculation area setting unit.

Furthermore, for achieving the above-mentioned purpose, a design supporting method according to the present invention comprises a spatial shape calculating step of calculating a spatial shape within a predetermined area of a structure on the basis of three-dimensional design data on the structure, a structural shape calculating step of calculating a structural shape within the predetermined area of the structure on the basis of the three-dimensional design data, a density calculating step of calculating a structural density or spatial density within the predetermined area of the structure on the basis of the spatial shape calculated in the spatial shape calculating step and the structural shape calculated in the structural shape calculating step, and a display control step of making a display unit display the structural density or spatial density calculated in the density calculating step.

Still furthermore, for achieving the above-mentioned purpose, in accordance with the present invention, there is provided a design supporting program for making a computer realize functions to execute a support for a design of a structure, the design supporting program making the computer function as a spatial shape calculating unit for calculating a spatial shape within a predetermined area of a structure on the basis of three-dimensional design data on the structure, a structural shape calculating unit for calculating a structural shape within the predetermined area of the structure on the basis of the three-dimensional design data, a density calculating unit for calculating a structural density or spatial density within the predetermined area of the structure on the basis of the spatial shape calculated by the spatial shape calculating unit and the structural shape calculated by the structural shape calculating unit, and a display control unit for making a display unit display the structural density or spatial density calculated by the density calculating unit.

As described above, according to the present invention, the design calculating unit calculates a packaging density or a spatial density within a predetermined area of a structure on the basis of a spatial shape calculated by the spatial shape calculating unit (in the spatial shape calculating step) and a structural shape calculated by the structural shape calculating unit (in the structural shape calculating step) and the display control unit puts the density calculated by the density calculating unit (in the density calculating step) on a display device. Therefore, for a verification of a density of a structure, an operator can recognize the density of the structure at a glance and, unlike the conventional technique, this can eliminate the need to seize the density of the structure by using a large number of two-dimensional cross sections, which enables the operator to carry out the efficient and accurate density verification even in the case of a complicated structure.

In addition, the density calculating unit calculates a density on the basis of a calculation direction set by the calculation direction setting unit, thereby enabling an operator to carry out an easy verification of the density according to a direction of the structure, which improves the convenience.

Still additionally, the density calculating unit calculates a density of a calculation area set by the calculation area setting unit, which enables the designation of only a specified area or the division of structure into a predetermined number of areas and yet which enables an operator to freely set an area to be density-verified, thus further improving the convenience of the density verification.

### BRIEF DESCRIPTION OF THE DRAWINGS

FIG. 1 is a block diagram showing an arrangement of a design supporting apparatus according to an embodiment of the present invention;

FIG. 2 is a block diagram showing one example of an arrangement of a computer for realizing a design supporting apparatus according to an embodiment of the present invention;

FIGS. 3 to 8 are illustrations useful for explaining an example of setting of a calculation direction by a calculation direction setting unit of a calculation method setting unit of a design supporting apparatus according to an embodiment of the present invention;

FIGS. 9(a) and 9(b) are illustrations of a structure, which is an object of processing, for explaining processing in a space-filling unit of a spatial shape calculating unit of a design supporting apparatus according to an embodiment of the present invention, and FIG. 9(a) is a perspective illustration of the structure when viewed from above while FIG. 9(b) is a perspective illustration of the structure when viewed from below;

FIGS. 10(a) and 10(b) are illustrations useful for explaining processing in a space-filling unit of a spatial shape calculating unit of a design supporting apparatus according to an embodiment of the present invention, and FIG. 10(a) shows a spatial shape calculated by the spatial shape calculating unit in a case in which the space-filling unit does not conduct the space-filling processing with respect to the structure shown in FIGS. 9(a) and 9(b) while FIG. 10(b) shows a spatial shape calculated by the spatial shape calculating unit in a case in which the space-filling unit conducts the space-filling processing with respect to the structure shown in FIGS. 9(a) and 9(b);

FIG. 11 is an illustration of an example of display of a density by a display control unit of a design supporting apparatus according to an embodiment of the present invention;

FIG. 12 is an illustration of an example of display of a density by a display control unit of a design supporting apparatus according to an embodiment of the present invention;

FIG. 13 is an illustration useful for explaining an example of extraction of a disposition-possible area by a disposition-possible area extracting unit of a design supporting apparatus according to an embodiment of the present invention;

FIG. 14 is an illustration useful for explaining an example of extraction of a disposition-possible area by a disposition-possible area extracting unit in a case in which a disposition inhibition area is set by a disposition inhibition area setting unit of a disposition-possible area extracting unit of a design supporting apparatus according to an embodiment of the present invention;

FIGS. 15(a) to 15(e) are illustrations useful for explaining an example of calculation of a spatial shape by a spatial shape calculating unit of a design supporting apparatus according to an embodiment of the present invention, and FIG. 15(a) is an illustration of a spatial shape calculated by the spatial shape calculating unit and a part which is an object of disposition change, FIG. 15(b) is an illustration of a spatial shape excluding an area for a part which is an object of disposition change, FIG. 15(c) is an illustration of a disposition-possible area extracted from the spatial shape shown in FIG. 15(b) by the disposition-possible area extracting unit, FIG. 15(d) is an illustration of a spatial shape including an area for a part which is an object of disposition change, and FIG. 15(e) is an illustration of a disposition-possible area extracted from the spatial shape shown in FIG. 15(d) by the disposition-possible area extracting unit;

FIGS. 16(a) and 16(b) are illustrations useful for explaining an example of shape change of a part by a shape changing unit of a design supporting apparatus according to an embodiment of the present invention, and FIG. 16(a) is an enlarged illustration of a part while FIG. 16(b) is a partially enlarged illustration of a part;

FIG. 17 is a flow chart useful for explaining a processing procedure of a design supporting method according to an embodiment of the present invention;

FIG. 18 is a flow chart useful for explaining a processing procedure of a design supporting method according to an embodiment of the present invention;

FIG. 19 is an illustration of an example of display of density by a display control unit of a design supporting apparatus according to an embodiment of the present invention;

FIG. 20 is an illustration of an example of display of a density by a display control unit of a design supporting apparatus according to an embodiment of the present invention;

FIG. 21 is an illustration of an example of display of a density by a display control unit of a design supporting apparatus according to an embodiment of the present invention;

FIG. 22 is an illustration of an example of display of a density by a display control unit of a design supporting apparatus according to an embodiment of the present invention;

FIG. 23 is a block diagram showing an arrangement of a design supporting apparatus according to a modification of the present invention;

FIG. 24 is a block diagram showing an arrangement of a design supporting apparatus according to a modification of the present invention;

FIG. 25 is an illustration of an example of a structure which is an object of processing in a design supporting apparatus according to an embodiment of the present invention; and

FIGS. 26(a) and 26(b) are illustrations of a spatial shape of a structure shown in FIG. 25, which is calculated by a spatial shape calculating unit of a design supporting apparatus according to an embodiment of the present invention, and FIG. 26(a) is a perspective illustration of the spatial shape when viewed from above while FIG. 26(b) is a perspective illustration of the spatial shape when viewed from below.

### DESCRIPTION OF THE PREFERRED EMBODIMENTS

Embodiments of the present invention will be described hereinbelow with reference to the drawings.

[1] About One Embodiment of the Present Invention

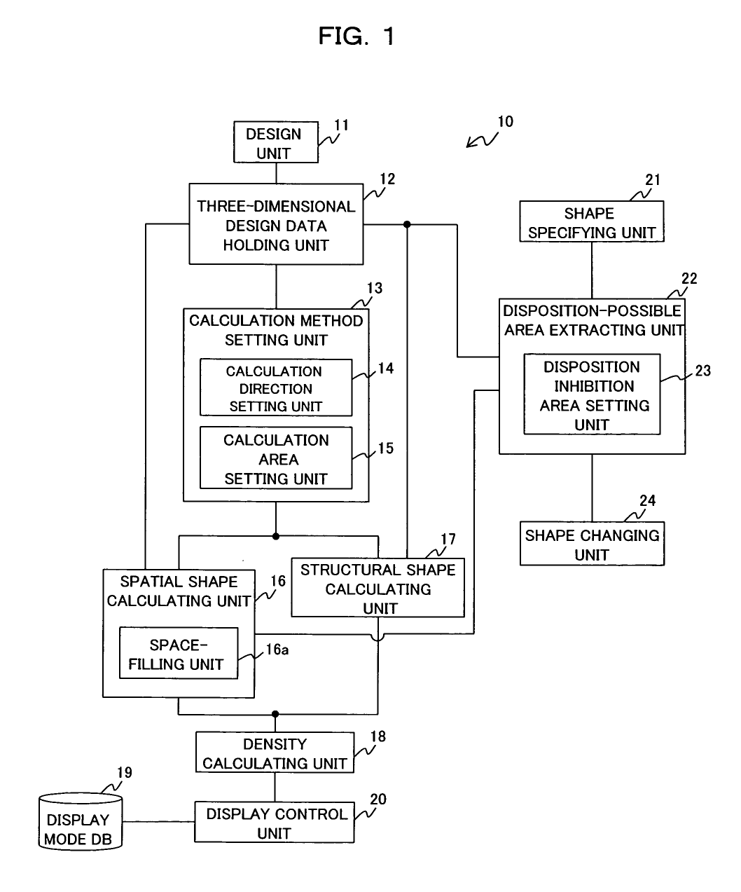

First of all, referring to a block diagram of FIG. 1, a description will be given hereinbelow of an arrangement of a design supporting (aid) apparatus according to an embodiment of the present invention. As shown in FIG. 1, the design supporting apparatus 10 is made up of a design unit 11, a three-dimensional design data holding unit 12, a calculation method setting unit 13, a spatial shape calculating unit 16, a structural shape calculating unit 17, a density calculating unit 18, a display mode database (in the illustration, written as “display mode DB”) 19, a display control unit 20, a shape specifying unit 21, a disposition-possible area extracting unit (extracting unit) 22 and a shape changing unit 24.

The design supporting apparatus 10 is, for example, CAD (Computer Aided Design) and is made to calculate a density (for example, a packaging density or a spatial density, which will be mentioned later) of a structure designed by the design unit 11, with the three-dimensional design data of the structure being held in the three-dimensional design data holding unit 12. Additionally, the design supporting apparatus 10 is further made to implement a display of the density so that an operator of the design supporting apparatus 10 (which will hereinafter be referred to simply as an “operator”) can recognize it at a glance and made to extract a disposition-possible area (region) for a part to be newly disposed in this structure.

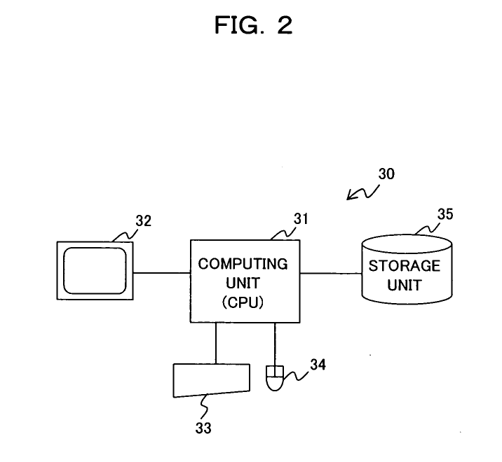

In addition, this design supporting apparatus 10 is realized by a computer 30 which includes, for example, a computing unit (for example, CPU: Central Processing Unit) 31, a display unit 32, a keyboard 33/mouse 34 serving as an input interface, and a storage unit 35 as shown in FIG. 2.

That is, in this design supporting apparatus 10, the three-dimensional design data holding unit 12 is realized by the storage unit 35. When the computing unit 31 implements a predetermined application program (design supporting program which will be mentioned later), the design unit 11, the calculation method setting unit 13, the spatial shape calculating unit 16, the structural shape calculating unit 17, the density calculating unit 18, the display control unit 20, the shape specifying unit 21, the disposition-possible area extracting unit 22 and the shape changing unit 24 are realized.

The display mode database 19 is realizable by the storage unit 35, and it is also realizable by, for example, a memory (not shown) provided in the computing unit 3.

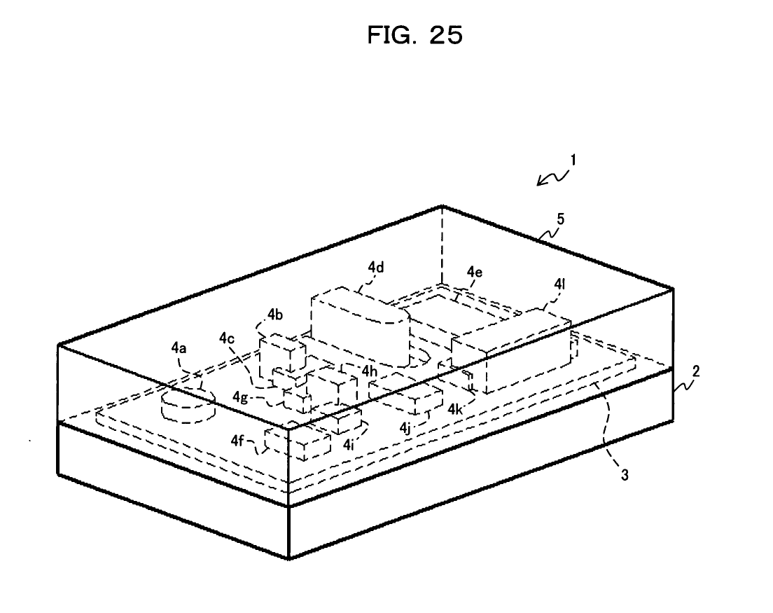

The design unit 11 is made to create three-dimensional design data by designing a structure on the basis of an instruction inputted by an operator through, for example, the keyboard 33 or the mouse 34 serving as an input interface. For example, the design unit 11 creates the three-dimensional design data on the hollow structure 1 made in a manner such that, as shown in FIG. 25, a printed-circuit board 3 is provided on an upper surface of a lower component 2 and parts 4a to 4l are mounted on the printed-circuit board 3 and an upper component 5 having a lid-like shape is joined to the lower component 2 so as to cover the printed-circuit board 3.

Moreover, the three-dimensional design data holding unit 12 holds the three-dimensional design data on the structure created by the design unit 11, that is, in a case in which the design unit 11 designs the structure 1, the three-dimensional design data holding unit 12 holds the three-dimensional design data on the structure 1.

A detailed description will be given hereinbelow of the calculation method setting unit 13, the spatial shape calculating unit 16, the structural shape calculating unit 17, the density calculating unit 18, the display mode database 19, the display control unit 20, the shape specifying unit 21, the disposition-possible area extracting unit 22 and the shape changing unit 24 in a case in which, as an example, this design supporting apparatus 10 targets the structure 1 shown in FIG. 25, that is, when the structure 1 is designed by the design unit 11 and the three-dimensional design data thereon is held in the three-dimensional design data holding unit 12.

The calculation method setting unit 13 is for setting a calculation method for a density of the structure 1 which is to be taken in the density calculating unit 18 and includes a calculation direction setting unit 14 and a calculation area setting unit 15.

The calculation direction setting unit 14 is for setting a density calculation direction which is to be taken in the density calculating unit 18 and, in this design supporting apparatus 10, the calculation area setting unit 15 is made to set a predetermined area (region) on the basis of the calculation direction set by the calculation direction setting unit 14 and the density calculating unit 18 is made to calculate a density within this predetermined area. Thus, the density calculating unit 18 calculates a density according to the calculation direction set by the calculation direction setting unit 14.

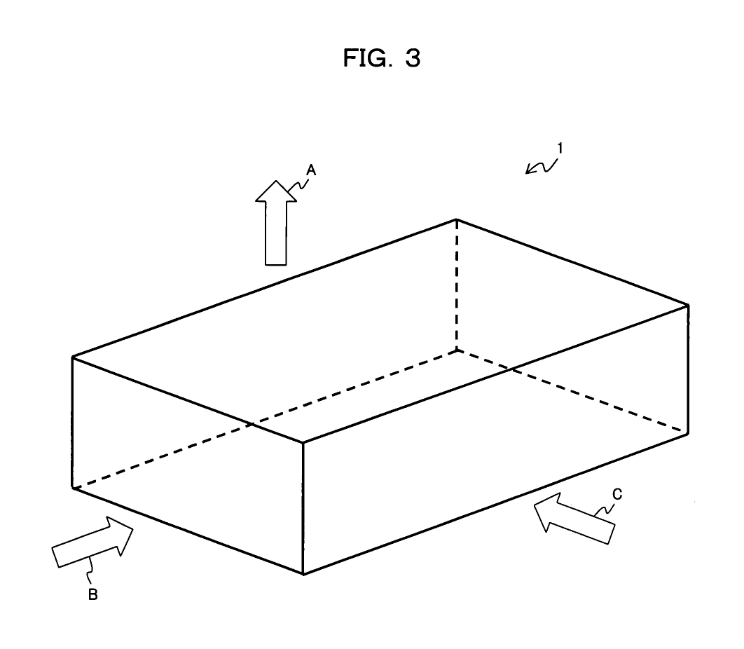

For example, as shown in FIG. 3, the calculation direction setting unit 14 sets a normal (perpendicular) direction to a part packaging plane (upper surface) of the printed-circuit board 3 as indicated by a block arrow A with respect to the structure 1, a horizontal direction as indicated by a block arrow B and a horizontal direction perpendicular to a longitudinal side surface of the structure 1 as indicated by a block arrow C. In FIGS. 3 and 4 to 8, which will be discussed later, only the external shape of the structure 1 is shown for simplicity of illustrations.

The calculation area setting unit 15 is for setting an area (calculation area) which is an object of density calculation to be made by the density calculating unit 18, and it sets one or a plurality of calculation areas according to a direction set by the calculation direction setting unit 14.

The calculation area setting unit 15 makes the display unit 32 display the structure 1 as shown in FIG. 25, and the operator drags the mouse 34 so as to set a selected area on the structure 1 as a calculation area. Moreover, the calculation area setting unit 15 divides this calculation area into a plurality of calculation areas on the basis of an operator's instruction inputted through the keyboard 33 or the mouse 34.

For example, in a case in which the calculation direction setting unit 14 sets the direction indicated by the block arrow A and the operator specifies the entire structure 1 and specifies the division into a plurality of (in this case, 8) areas, the calculation area setting unit 15 divides the structure 1 along the direction of the block arrow A as shown in FIG. 4 so as to set a plurality of calculation areas 1a to 1h.

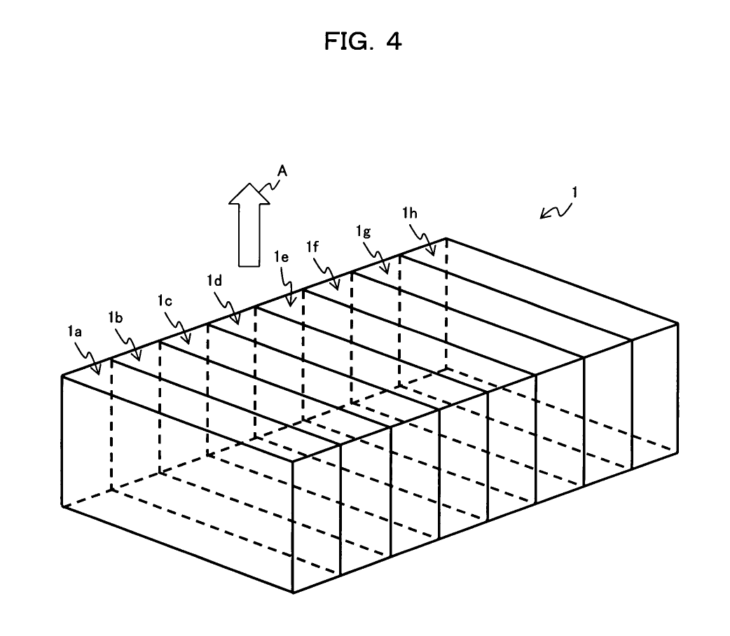

On the other hand, in a case in which the calculation direction setting unit 14 sets the direction indicated by the block arrow B and the operator specifies the entire structure 1 and specifies the division into a plurality of (in this case, 4) areas, the calculation area setting unit 15 divides the structure 1 along the direction of the block arrow B as shown in FIG. 5 so as to set a plurality of calculation areas 1i to 1l.

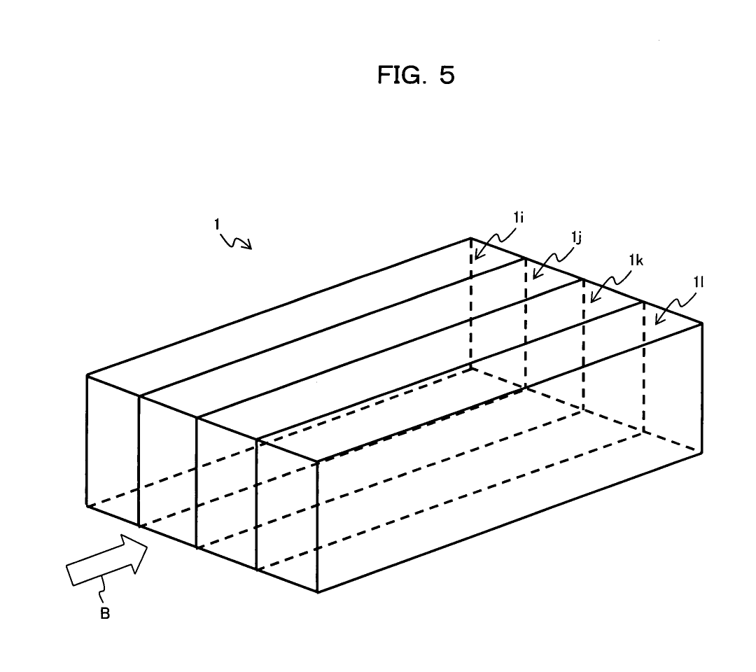

Moreover, in a case in which the calculation direction setting unit 14 sets the direction indicated by the block arrow C and the operator specifies the entire structure 1 and specifies the division into a plurality of (in this case, 3) areas, the calculation area setting unit 15 divides the structure 1 along the direction of the block arrow C as shown in FIG. 6 so as to set a plurality of calculation areas 1m to 1o.

Incidentally, in the examples shown in FIGS. 4 to 6, it is also appropriate that, without depending on the instruction from the operator, the number of divisions of the structure 1 to be made by the calculation area setting unit 15 along each of the directions A to C set by the calculation direction setting unit 10 is previously set according to the structure 1 or the size of the specified calculation area.

Still moreover, according to the present invention, the calculation area to be set by the calculation area setting unit 15 is not limited to the above-mentioned examples shown in FIGS. 4 to 6, but arbitrary setting is acceptable.

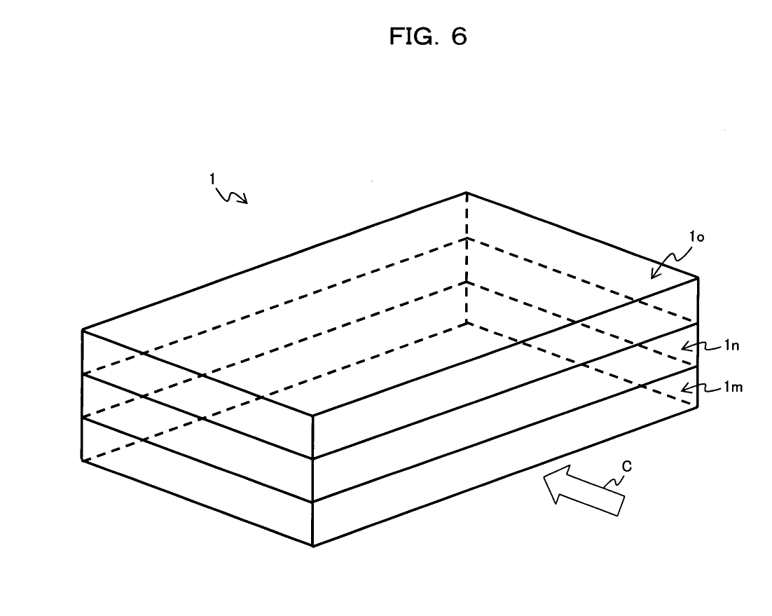

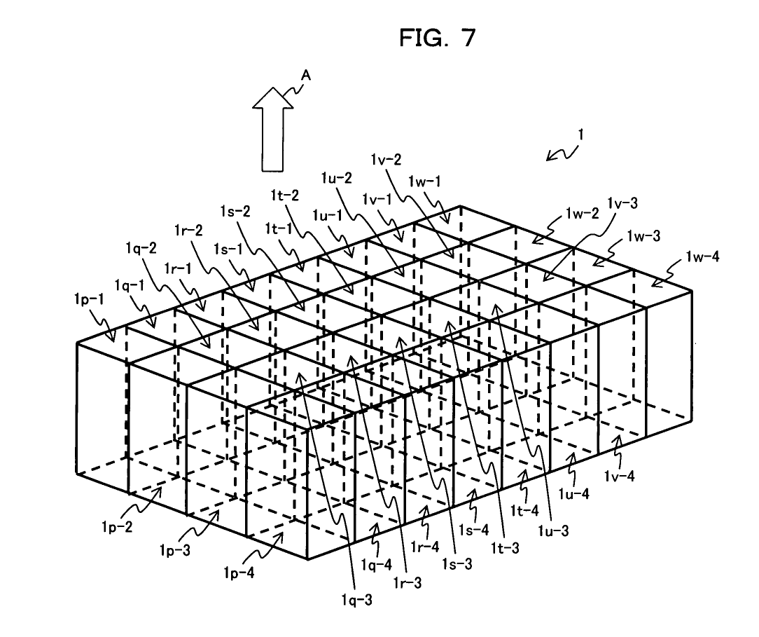

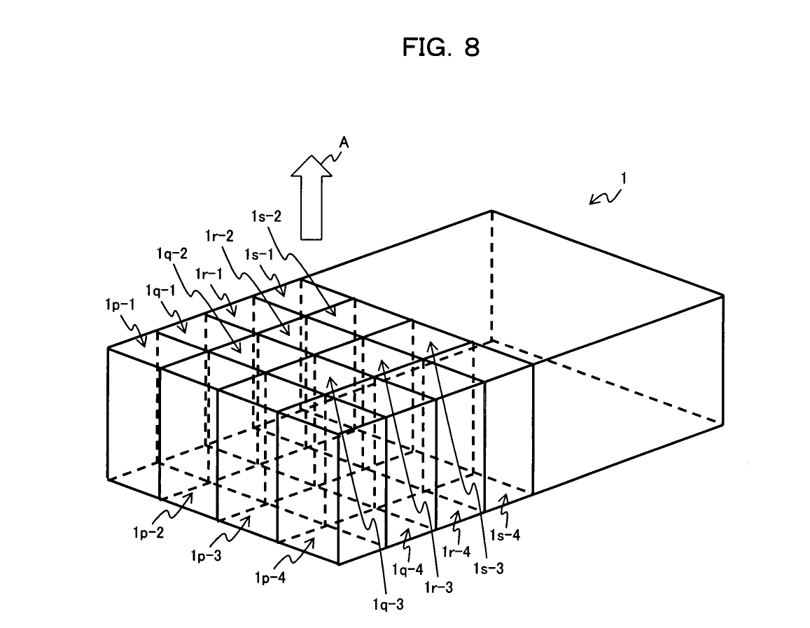

For example, in a case in which the calculation direction setting unit 14 sets the direction indicated by the block arrow A, the calculation area setting unit 15 can divide the structure 1 equally into 32 sections as shown in FIG. 7 so as to set, as the calculation areas, 32 areas 1p-1 to 1p-4, 1q-1 to 1q-4, 1r-1 to 1r-4, 1s-1 to 1s-4, 1t-1 to 1t-4, 1u-1 to 1u-4, 1v-1 to 1v-4 and 1w-1 to 1w-4 (in a case in which these 32 calculation areas are not discriminated particularly, the reference numerals are partially omitted and the 32 calculation areas are designated at reference numerals “1p-1 to 1w-4”), or the calculation area setting unit 15 can also divide the half of the structure 1 equally into 16 sections as shown in FIG. 8 so as to set, as the calculation areas, 16 areas 1p-1 to 1p-4, 1q-1 to 1q-4, 1r-1 to 1r-4 and 1s-1 to 1s-4 (in a case in which these 16 calculation areas are not discriminated particularly, the reference numerals are partially omitted and the 16 calculation areas are designated at reference numerals “1p-1 to 1s-4”).

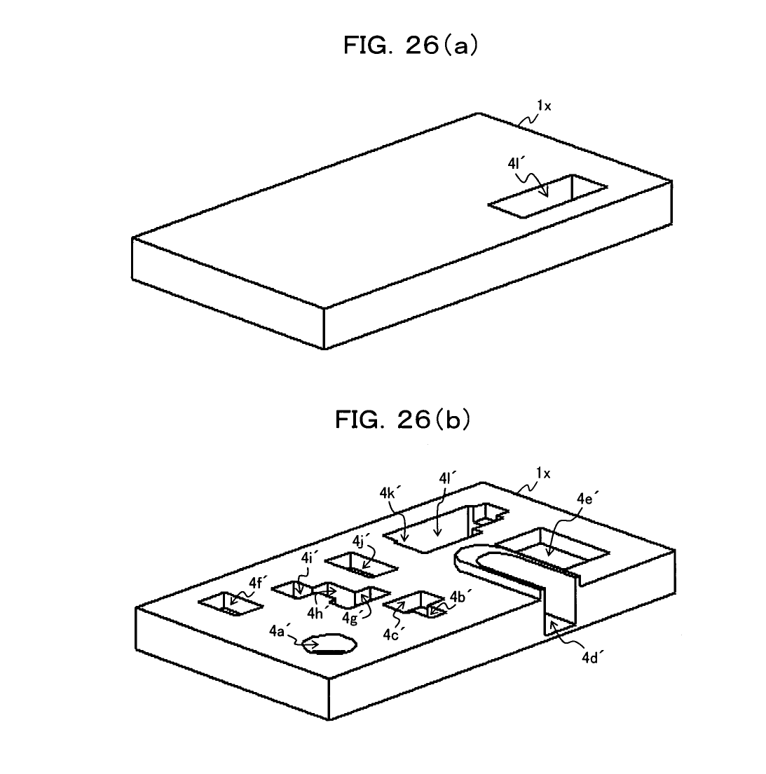

The spatial shape calculating unit 16 calculates a spatial shape within a predetermined area (in this case, within the calculation area set by the calculation area setting unit 15) of the structure 1 on the basis of the three-dimensional design data on the structure 1 held in the three-dimensional design data holding unit 12 and, for example, in a case in which the calculation area set by the calculation area setting unit 15 covers the entire structure 1, calculates the spatial shape (reverse model) 1x shown in FIGS. 26(a) and 26(b).

As mentioned above, FIG. 26(a) is a perspective view showing the spatial shape 1x when the structure 1 shown in FIG. 25 is viewed from above and, in FIG. 26(a), a cavity-like portion having a rectangular parallelepiped shape and designated at reference numeral 4l′ corresponds to a part 4l, and FIG. 26(b) is a perspective view showing the spatial shape 1x when the structure 1 shown in FIG. 25 is viewed from below, i.e., a perspective illustration when the spatial shape 1x shown in FIG. 26(a) is viewed from the rear side and, in FIG. 26(b), cavity-like portions designated at reference numerals 4a′ to 4l′ correspond to parts 4a to 4l, respectively.

Moreover, for example, in a case in which the area forming the half of the structure 1 as shown in FIG. 8 is set as a calculation area by the calculation area setting unit 15, the spatial shape calculating unit 16 calculates a spatial shape of an area forming the half of the structure 1 which corresponds to this calculation area.

Still moreover, the spatial shape calculating unit 16 includes a space-filling unit 16a.

Of the components or parts of the structure 1, with respect to the components or parts each having one or a plurality of spaces (clearance gaps; each of which is hereinafter referred to as a “disposition-impossible space”) such as heat-radiation holes or slits made as small as denying a possibility of disposition of other parts, the space-filling unit 16a carries out the space-filling (padding) so as to handle the disposition-impossible spaces as being nonexistent therein.

When the space-filling unit 16a has conducted the space-filling with respect to the disposition-impossible space, the spatial shape calculating unit 16 calculates a spatial shape on the assumption that the disposition-impossible space is nonexistent.

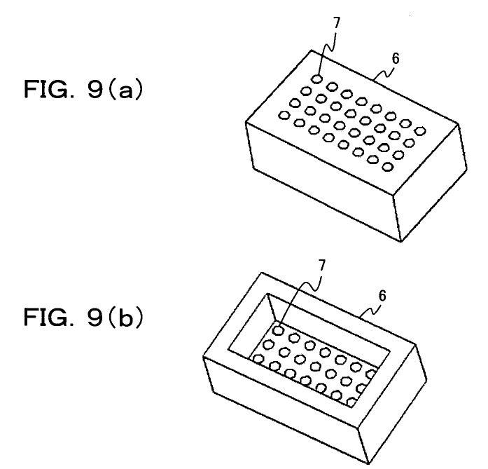

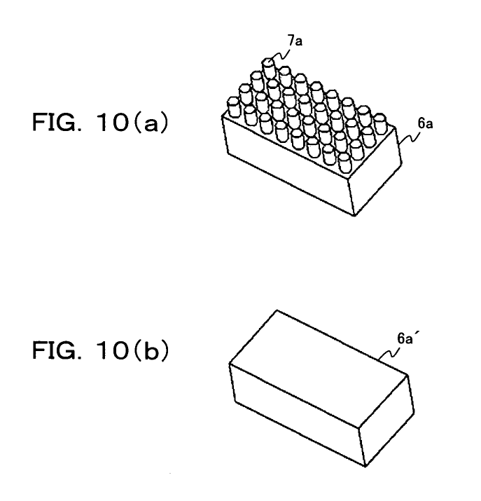

Referring to FIGS. 10(a) and 10(b), a description will be given hereinbelow of examples of operations of the spatial shape calculating unit 16 and the space-filling unit 16a in a case in which this design supporting apparatus 10 carries out the processing on a structure 6 shown in FIGS. 9(a) and 9(b) and having a plurality of heat-radiation holes, i.e., a plurality of disposition-impossible spaces 7.

The structure 6 shown in FIGS. 9(a) and 9(b) has a lid-like shape, and FIG. 9(a) is a perspective illustration of the structure 6 when viewed from above (front side) while FIG. 9(b) is a perspective illustration of the structure 6 when viewed from below (rear side). In FIGS. 9(a) and 9(b), for simplicity of illustrations, only one reference numeral “7” is typically used for depicting the plurality of disposition-impossible spaces, and all the same holes as the hole designated at the reference numeral “7” in FIGS. 9(a) and 9(b) are the disposition-impossible spaces.

In a case in which the space-filling unit 16a does not carry out the space-filling with respect to the structure 6, as shown in FIG. 10(a), the spatial shape calculating unit 16 calculates a spatial shape 6a having cylindrical projections 7a corresponding to the plurality of disposition-impossible spaces 7.

In FIG. 10(a), for simplicity of illustration, only one reference numeral “7a” is typically used for depicting the plurality of projections corresponding to the plurality of disposition-impossible spaces 7, and all the same projections as the projection designated at the reference numeral “7a” in FIG. 10(a) are the projections corresponding to the disposition-impossible spaces 7.

On the other hand, in a case in which the space-filling unit 16a carries out the space-filling with respect to the structure 6, as shown in FIG. 10(b), the spatial shape calculating unit 16 disregards the plurality of disposition-impossible spaces 7 of the structure 6 so as to calculate a spatial shape 6a′ having a mere rectangular parallelepiped shape. That is, when the space-filling unit 16a carries out the space-filling, the spatial shape calculating unit 16 calculates the spatial shape 6a′ of the structure 6 on the assumption that the disposition-impossible spaces 7 are nonexistent.

Thus, when the space-filling is set by the space-filling unit 16a, the spatial shape calculating unit 16 calculates a spatial shape of the space-filling set structure on the condition that the disposition-impossible space is nonexistent in the structure (or component).

The structural shape calculating unit 17 calculates a structural shape within a predetermined area in the structure 1 (in this case, within a calculation area set by the calculation area setting unit 15) on the basis of the three-dimensional design data on the structure 1 held in the three-dimensional design data holding unit 12.

In this case, the structural shape signifies a shape of a component (part) constituting the structure 1 within a predetermined area of the structure 1, that is, it corresponds to an external shape of the lower component 2, the printed-circuit board 3, packaging parts 4a to 4l and the upper component 5 in the structure 1 shown in FIG. 25.

The density calculating unit 18 is made to calculate a density (structural density; hereinafter referred to as a “packaging density”) of the components (parts) of the structure 1 or a density (hereinafter referred to as a “spatial density”) of a clearance gap (space) thereof with respect to a calculation direction set by the calculation direction setting unit 14 and a calculation area set by the calculation area setting unit 15 on the basis of a spatial shape 1x calculated by the spatial shape calculating unit 16 and a structural shape calculated by the structural shape calculating unit 17. In the following description, when the packaging density and the spatial density are not discriminated particularly from each other, they will be referred to simply as a “density”.

Concretely, on the basis of a volume D of a spatial shape 1x calculated by the spatial shape calculating unit 16 and a volume E of a structural shape calculated by the structural shape calculating unit 17, the density calculating unit 18 calculates a packaging density F according to the following equation (1) and further calculates a spatial density G according to the following equation (2).

F=E/(D+E) (1)

G=D/(D+E) (2)

In this connection, it is also appropriate that the volume D of the spatial shape is calculated after the spatial shape calculating unit 16 calculates the spatial shape 1x or at the time that the density calculating unit 18 calculates a density, and that the volume E of the structural shape is calculated after the structural shape calculating unit 17 calculates a structural shape, or at the time that the density calculating unit 18 calculates a density. The present invention is not limited to these.

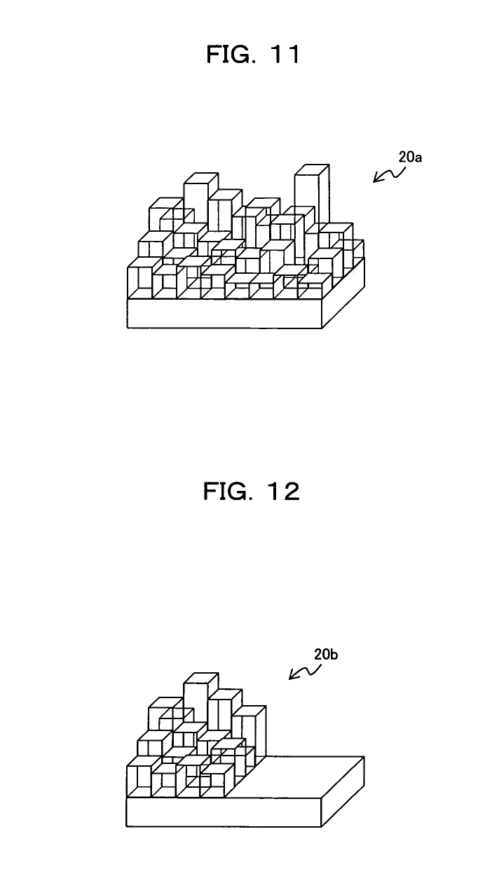

The display mode database 19 holds a plurality of formats (for example, bar graph formats shown in FIGS. 11 and 12 and mentioned later) related to display modes to be used when the display control unit 20 displays a density, calculated by the density calculating unit 18, on the display unit 32.

That is, the display control unit 20 controls a display of a density on the display unit 32 on the basis of a format (mode; form) held in the display mode database 19. The designation of this format is conducted according to an operator's instruction inputted through, for example, the keyboard 33 or the mouse 34.

Concretely, in a case in which the density calculating unit 18 calculates the packaging densities of the calculation areas 1p-1 to 1w-4 set by the calculation method setting unit 13 as shown in FIG. 7, when a three-dimensional bar graph format in the display mode database 19 is designated, as shown in FIG. 11, the display control unit 20 makes the display unit 32 display a bar graph 20a corresponding to the direction A set by the calculation direction setting unit 14 and the calculation areas 1p-1 to 1w-4 set by the calculation area setting unit 15.

With respect to the bar graph 20a shown in FIG. 11, the packaging density increases as the height of the bars of the bar graph 20a becomes higher.

Moreover, in a case in which the density calculating unit 18 calculates the packaging densities of the calculation areas 1p-1 to 1s-4 set by the calculation method setting unit 13 as shown in FIG. 8, when a three-dimensional bar graph format in the display mode database 18 is designated, as shown in FIG. 12, the display control unit 20 makes the display unit 32 display a bar graph 20b corresponding to the direction A set by the calculation direction setting unit 14 and the calculation areas 1p-1 to 1s-4 set by the calculation area setting unit 15.

With respect to the bar graph 20a shown in FIG. 11 and the bar graph 20b shown in FIG. 12, the packaging density increases as the height of the bars thereof becomes higher.

Thus, since the display control unit 20 makes the display unit 32 display a density distribution of the structure 1 with respect to the calculation direction and the calculation areas set by the calculation method setting unit 13 on the basis of the display mode database 19, the operator can recognize the densities of the structure 1 by merely taking one look at these bar graphs 20a and 20b.

The shape specifying unit 21 is for specifying a shape (in this case, three-dimensional shape) of a desired part (hereinafter referred to as a “disposition part (part which is an object of disposition)”) to be newly disposed in the structure 1 whose three-dimensional design data is held in the three-dimensional design data holding unit 12.

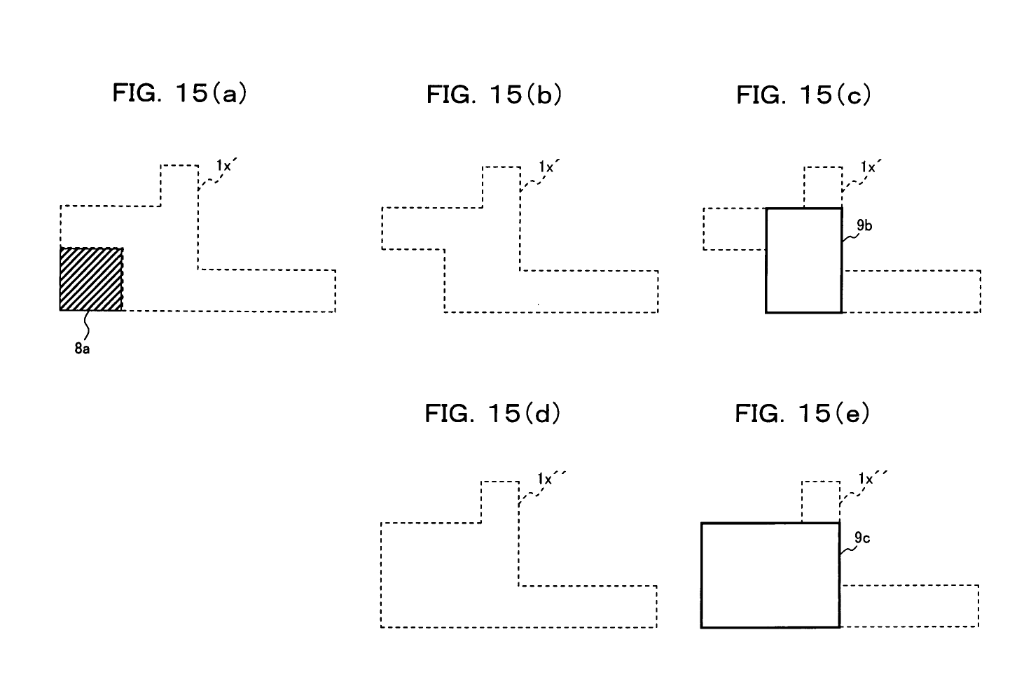

In this case, the shape specifying unit 21 can also specify an existing part constituting the structure 1 as a disposition part. That is, when changing the disposition of the existing part, the shape specifying unit 21 specifies this existing part as the disposition part. At this time, as will be described in detail with reference to FIGS. 15(a) to 15(e) later, the spatial shape calculating unit 16 is made to calculate, as a spatial shape, a three-dimensional area (i.e., equaling the shape of the existing part), where the existing part has originally been disposed as a disposition part, in accordance with an instruction from the operator.

The disposition-possible area extracting unit 22 is made to extract, from a spatial shape 1x calculated by the spatial shape calculating unit 16, a disposition-possible area (disposition-possible region), where a disposition part can be disposed, on the basis of a shape of a part specified by the shape specifying unit 21.

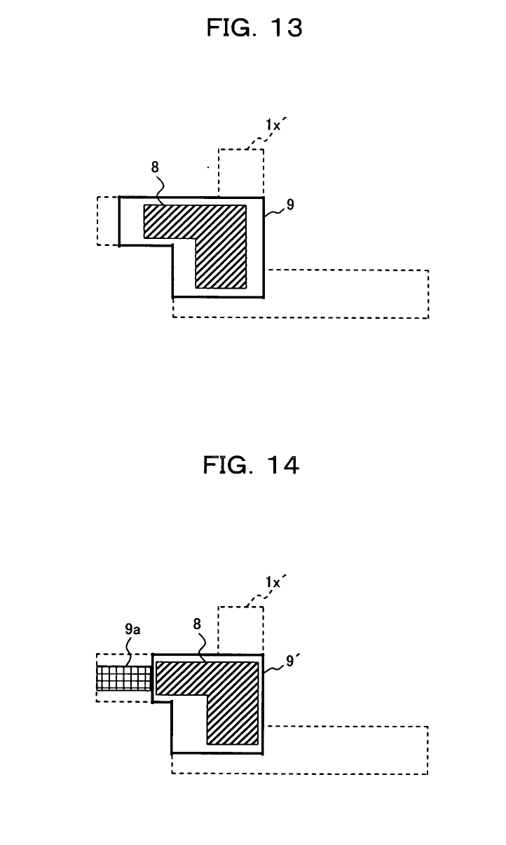

Referring to FIG. 13, a description will be given hereinbelow of a concrete example of an operation of the disposition-possible area extracting unit 22. In FIG. 13, for simplicity of illustration, a spatial shape 1x′ indicated by a broken line is shown by two-dimensionally expressing a portion of the aforesaid spatial shape 1x shown in FIGS. 26(a) and 26(b) and, likewise, for simplicity of illustration, a part (disposition part) 8 specified by the shape specifying unit 21 is expressed two-dimensionally. Although FIG. 13 shows two-dimensionally the spatial shape 1x′ and the shape of the disposition part 8 for simplicity of illustration, in fact the disposition-possible area extracting unit 22 conducts the processing on the basis of three-dimensional data. Moreover, FIGS. 14, 15(a) to 15(e), 16(a) and 16(b) also show two-dimensionally the spatial shape 1x′, disposition parts 8, 8a to 8c and others for simplicity of illustration.

The example shown in FIG. 13 relates to a case in which the disposition part 8 specified by the shape specifying unit 21 is newly disposed on the printed-circuit board of the structure 1 and, in this case, the disposition-possible area extracting unit 22 extracts, from the spatial shape 1x′, a disposition-possible area (see a thick solid line in the illustration) 9, where the disposition of the part 8 is possible, on the basis of a shape of the disposition part 8 specified by the shape specifying unit 21 and a spatial shape 1x(in this case, shown is only the spatial shape 1x′ forming a portion of the spatial shape 1x) calculated by the spatial shape calculating unit 16.

In addition, the disposition-possible area extracting unit 22 has a disposition inhibition area setting unit 23.

The disposition inhibition area setting unit 23 is for setting an area (hereinafter referred to as a “disposition inhibition area”) in which it is inhibited to dispose a part newly in the spatial shape 1x. For example, a disposition inhibition area 9a is set in the spatial shape 1x′ as shown in FIG. 14.

In this case, the disposition-possible area extracting unit 22 extracts a disposition-possible area 9′ according to the disposition inhibition area 9a set by the disposition inhibition area setting unit 23.

Furthermore, referring to FIGS. 15(a) to 15(e), a description will be given hereinbelow of a case in which the shape specifying unit 21 specifies, as a disposition part 8a, an existing part 8a constituting the structure 1.

As shown in FIG. 15(a), in a case in which the shape specifying unit 21 specifies, as a disposition part 8a, the part 8a disposed to be adjacent to the spatial shape 1x′, when an operator gives an instruction to the effect that an area in which the disposition part 8a has originally been disposed is excluded from the spatial shape 1x′, as shown in FIG. 15(b), the spatial shape calculating unit 16 calculates the spatial shape 1x′ without considering the area where the disposition part 8a has originally been disposed, and as shown in FIG. 15(c), the disposition-possible area extracting unit 22 extracts a disposition-possible area 9b.

On the other hand, when the operator gives an instruction to the effect that an area in which the disposition part 8a has originally been disposed is included in the spatial shape 1x′, as shown in FIG. 15(d), the spatial shape calculating unit 16 calculates a spatial shape 1x″ defined in a state where the area in which the disposition part 8a has originally been disposed is included in the spatial shape 1x′, and as shown in FIG. 15(e), the disposition-possible area extracting unit 22 extracts a disposition-possible area 9c.

The shape changing unit 24 is changing a shape of a desired part, which is an object of disposition, on the basis of the disposition-possible area extracted by the disposition-possible area extracting unit 22.

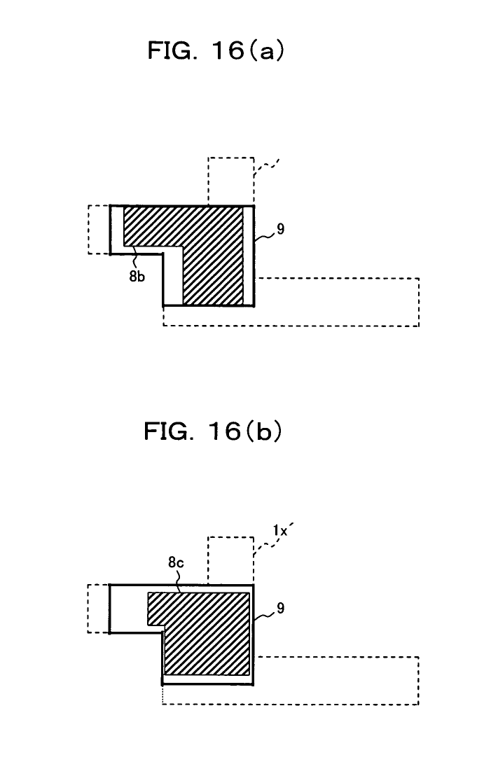

For example, in the case of the extraction of the aforesaid disposition-possible area 9 shown in FIG. 13, the shape changing unit 24 enlarges the shape of the part 8 up to a maximum within the disposition-possible area 9 as shown in FIG. 16(a) to change the aforesaid part 8 shown in FIG. 13 to a part 8b, or the shape changing unit 24 changes a portion of the shape of the part 8 greatly within the disposition-possible are 9 as shown in FIG. 16(b) to change the aforesaid part 8 shown in FIG. 13 to a part 8c.

In this connection, the change of the shape of a disposition part by the shape changing unit 24 is automatically made according to an instruction to the effect of a shape change from an operator, which is inputted through the keyboard 33, the mouse 34 or the like.

Moreover, the present invention is not limited to the contents of the change of the shape of the part 8 in the shape changing unit 24, but every change including a reduction of the shape of the part 8 is also acceptable, provided that it is made within the disposition-possible area 9.

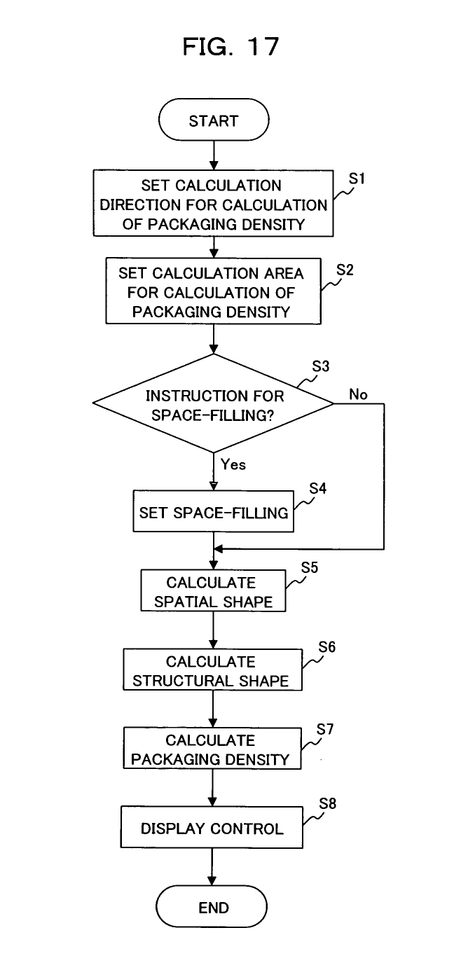

Secondly, referring to a flow chart (steps S1 to S8) of FIG. 17, a description will be given hereinbelow of an operation procedure (design supporting method according to the present invention) of the calculation method setting unit 13, the spatial shape calculating unit 16, the structural shape calculating unit 17, the density calculating unit 18 and the display control unit 20 in this design supporting apparatus 10.

First of all, the calculation direction setting unit 14 of the calculation method setting unit 13 sets a calculation direction for a calculation of a density (in this case, packaging density) (step S1; calculation direction setting step), and the calculation area setting unit 15 sets a calculation area for a calculation of a packaging density (step S2; calculation area setting step).

In this case, although the setting of the calculation area by the calculation area setting unit 15 is conducted according to an operator's instruction inputted through the keyboard 33, the mouse 34 or the like, the calculation area setting unit 15 can also be arranged so as to set the entire area of the structure as the calculation area when there is no instruction from the operation.

Moreover, if there exists a space-filling instruction from the operator through the keyboard 33, the mouse 34 or the like (Yes route from step S3), the space-filling unit 16a executes the setting of space-filling so as to place the disposition-impossible space in the calculation area into a nonexistent condition (step S4; space-filling step).

On the other hand, if there exists no space-filling instruction from the operator (No route from step S3), the space-filling unit 16a does not conduct the processing in the aforesaid step S4.

Following this, the spatial shape calculating unit 16 calculates a spatial shape in the calculation area set by the calculation area setting unit 15 on the basis of the presence or absence of the setting of space-filling by the space-filling unit 16a (step S5; spatial shape calculating step).

In addition, the structural shape calculating unit 17 calculates a structural shape in the calculation area set by the calculation area setting unit 15 (step S6; structural shape calculating step).

In the present invention, the execution order of the spatial shape calculation processing by the spatial shape calculating unit 16 and the structural shape calculation processing by the structural shape calculating unit 17 is not limited to the above-mentioned sequence, but these calculation processing can be executed before at least the execution of a density calculating step (step S7) which will be mentioned below.

Subsequently, the density calculating unit 18 calculates a packaging density with respect to the calculation direction set in the aforesaid step S1 and the calculation area set in the aforesaid step S2 on the basis of the spatial shape calculated in the aforesaid step S5 and the structural shape calculated in the aforesaid step S6 (step S7; density calculating step).

Moreover, the display control unit 20 places the packaging density calculated in the aforesaid step S7 into a chart (see FIGS. 11 and 12) on the basis of a format held in the display mode database 19 and displays it on the display unit 32 (step S8; display control step). Then, the processing comes to an end.

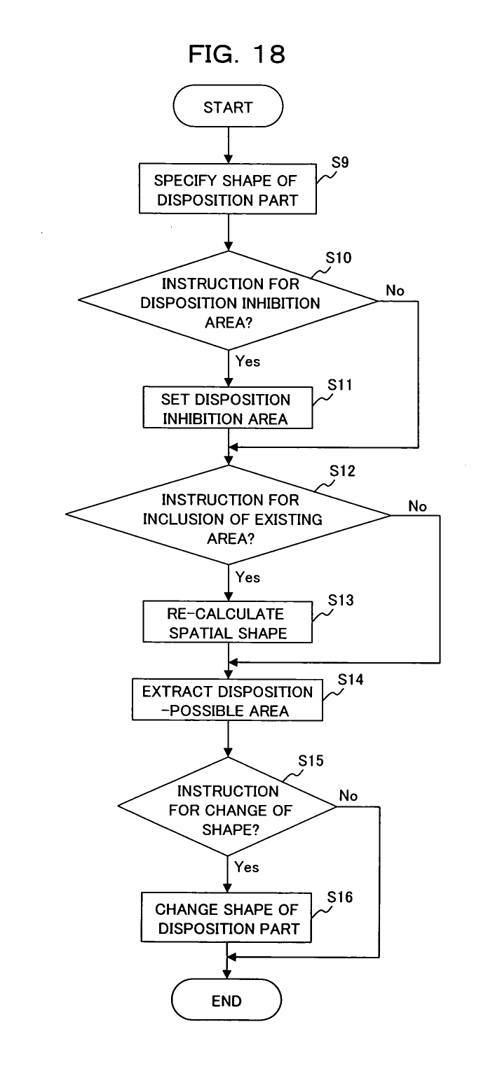

Secondly, referring to a flow chart (steps S9 to S16) of FIG. 18, a description will be given hereinbelow of an operation procedure (design supporting method according to the present invention) of the spatial shape calculating unit 16, the shape specifying unit 21, the disposition-possible area extracting unit 22 and the shape changing unit 24 in this design supporting apparatus 10.

First, the shape specifying unit 21 specifies a shape of a disposition part (step S9; shape specifying step).

Following this, if there is an instruction for a disposition inhibition area from the operator through the keyboard 33, the mouse 34 or the like (Yes route from step S10), the disposition inhibition area setting unit 23 sets a disposition inhibition area (step S11; disposition inhibition area setting step).

On the other hand, if there is no instruction for the disposition inhibition area from the operator (No route from step S10), the disposition inhibition area setting unit 23 does not carry out the processing in the step S11.

Moreover, in a case in which the disposition part specified by the shape specifying unit 21 in the processing of the aforesaid step S9 is an existing part and there is an instruction from the operator through the keyboard 33, the mouse 34 or the like to the effect that the existing area where the disposition part has been disposed is included in the spatial shape (Yes route from step S12), the spatial shape calculating unit 16 re-calculates a spatial shape including this existing area (step S13).

On the other hand if there is no instruction from the operator to the effect that the existing rear is included in the spatial shape (No route from step S12), the spatial shape calculating unit 16 does not carry out the processing in the step S13.

Still moreover, the disposition-possible area extracting unit 22 extracts a disposition-possible area, where the disposition part shape-specified by the shape specifying unit 21 can be disposed, from the spatial shape calculated or re-calculated by the spatial shape calculating unit 16, on the basis of a shape of the disposition part (step S14; extracting step).

Yet moreover, when there is an instruction from the operator through the keyboard 33, the mouse 34 or the like to the effect of a change of the shape of the disposition part (Yes route from step S15), the shape changing unit 24 changes the shape of the disposition part on the basis of the disposition-possible area extracted by the disposition-possible area extracting unit 22 in the aforesaid step S14 (step S16; shape changing step). Then, the processing comes to an end.

On the other hand, if there is no instruction from the operator to the effect of the change of the shape of the disposition part (No route from step S15), the shape changing unit 24 does not carry out the processing in the aforesaid step S16a, and the processing comes to an end.

As described above, according to the design supporting apparatus 10 of an embodiment of the present invention, the density calculating unit 18 calculates a packaging density or a spatial density within a predetermined area of the structure 1 on the basis of the spatial shape 1x calculated by the spatial shape calculating unit 16 and the structural shape calculated by the structural shape calculating unit 17, and the display control unit 20 makes the display unit 32 display the density calculated by the density calculating unit 18, thereby enabling the operator to recognize the density of the structure 1 at a glance and eliminating the need for the operator to seize the density of the structure 1 through the use of a large number of two-dimensional cross sections, which allows efficient and accurate density verification even if the structure 1 has a complicated configuration.

In addition, since the density calculating unit 18 calculates a density on the basis of a calculation direction set by the calculation direction setting unit 14, the operator can easily verify the density in a direction of the structure 1, which improves the convenience.

Still additionally, since the density calculating unit 18 calculates a density of a calculation area set by the calculation area setting unit 15, it is possible to not only designate only a specified area but also divide the structure 1 into a predetermined number of regions and even freely set an area to be density-verified by the operator, which further improves the convenience of the density verification.

Yet additionally the spatial shape calculating unit 16 and the structural shape calculating unit 17 calculate a spatial shape 1x and a structural shape with respect to a calculation area set by the calculation area setting unit 15. This can target a calculation of only a portion of the structure 1 specified by the operator, which enables more efficient and prompt calculation processing in comparison with the calculation on the entire structure 1.

Moreover, the space-filling unit 16a carries out the setting of space-filling with respect to disposition-impossible spaces in a component of the structure 1 so that the spatial shape calculating unit 16 calculates a spatial shape 6a′ on the assumption that these disposition-impossible spaces do not exist. This can exclude spaces as small as denying a possibility of disposition of other parts, which enables the density to be calculated by the density calculating unit 18 to be brought closer to a realistic value, thereby achieving the density verification with high accuracy.

Still moreover, in a case in which the calculation area setting unit 15 sets, as calculation areas, as plurality of areas obtained by dividing a portion of or whole of the structure 1, the display control unit 20 makes the display unit 32 display a density distribution of the structure 1 on the basis of the densities of the plurality of calculation areas and a format held in the display mode database 19. Therefore, the operator can recognize the density distribution of the structure 1, i.e., the density ununiformity, the density of a specified area and others, at a glance, which permits more detailed and efficient density verification with respect to the structure 1.

Yet moreover, the disposition-possible area extracting unit 22 extracts a disposition-possible area 9 for a disposition part 8 specified shape-specified by the shape specifying unit 21 from a spatial shape 1x(1x′) calculated by the spatial shape calculating unit 16. This enables the reliable extraction of the disposition-possible area 9 for the disposition part 8 while utilizing the spatial shape 1x′ effectively.

That is, in a conventional art, an operator prepares a large number of two-dimensional cross sections and retrieves a disposition-possible area for the disposition part 8 while viewing these two-dimensional cross sections, which needs a lot of operator's labor and takes a long time for the retrieval. On the other hand, according to this design supporting apparatus 10, the disposition-possible area extracting unit 22 automatically extracts the disposition-possible area 9 while utilizing the spatial shape 1x′ effectively, which can considerably reduce the operator's labor and can achieve the extraction of the disposition-possible area 9 with extremely high efficiency and within a short time.

In addition, since the disposition inhibition area setting unit 23 sets a disposition inhibition area 9a in the spatial shape 1x′ where the disposition of a part is inhibited and the disposition-possible area extracting unit 22 extracts a disposition-possible area 9′ to the disposition inhibition area 9a, the operator can freely set an area in which he/she does not want to dispose a part, which leads to the improvement of convenience.

Still additionally, the shape changing unit 24 changes the shape of the disposition part 8 on the basis of the disposition-possible area 1x′ extracted by the disposition-possible area extracting unit 22 and the shape of the disposition part 8 specified by the shape specifying unit 21, thereby accomplishing the improvement of convenience at the design by the operator.

Yet additionally, in a case in which the shape specifying unit 21 sets an existing part of the structure 1 as a disposition part 8, the spatial shape calculating unit 16 puts the area, where this existing part has been placed, in the spatial shape 1x″, thereby enabling the disposition change of the disposition part 8 to be made more accurately.

[2] Others

It should be understood that the present invention is not limited to the above-described embodiment, and that it is intended to cover all changes and modifications of the embodiment of the invention herein which do not constitute departures from the spirit and scope of the invention.

Although in the above description of the embodiment the bar graphs 20a and 20b shown in FIGS. 11 and 12 are employed as a density display mode on the display unit 32 by the display control unit 20, the display format to be taken by the display control unit 20 according to the present invention is not limited to the bar graphs 20a and 20b shown in FIGS. 11 and 12, and various changes are also acceptable.

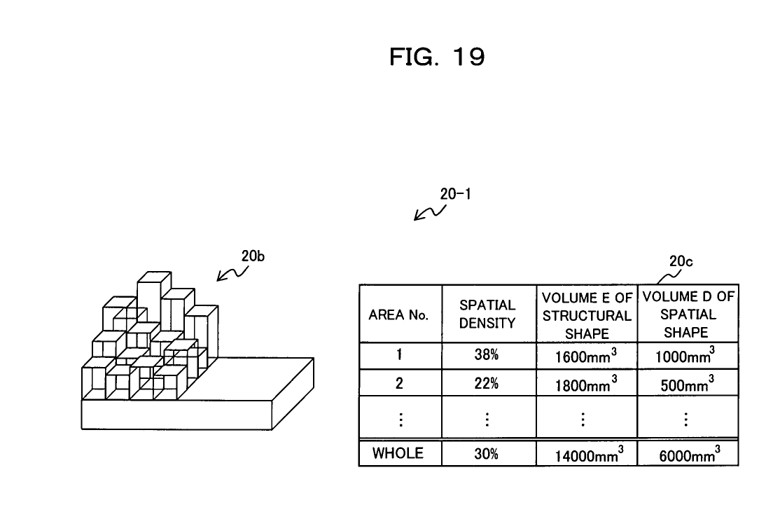

For example, it is also appropriate that, on the basis of a format held in the display mode database 19, as shown in FIG. 19, the display control unit 20 makes the display unit 32 display, as a display screen 20-1, the bar graph (density distribution) 20b shown in FIG. 12 and a table 20c having numeric values (in this case, Area No., Spatial Density (%), Volume E of Structural Shape and Volume D of Spatial Shape) corresponding to the bar graph 20b.

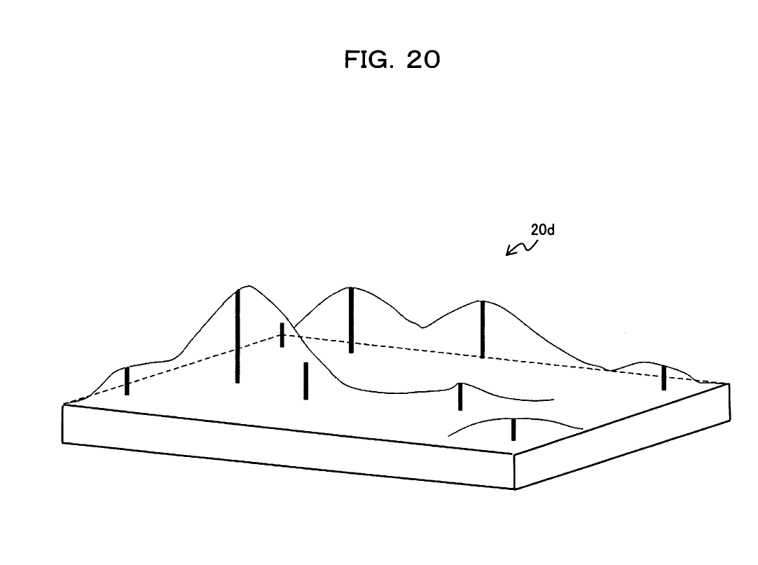

Moreover, it is also appropriate that, on the basis of the display mode database 19, as shown in FIG. 20, the display control unit 20 displays a three-dimensional graph 20d in which a plurality of arbitrary points are set as vertexes. At this time, preferably, the calculation method setting unit 13 or the display control unit 20 sets a plurality of vertexes on the basis of an instruction from the operator.

Still moreover, the structure to be density-displayed on the display unit 32 by the display control unit 20 is not limited to only one, but the densities of a plurality of structures can also be displayed simultaneously on the display unit 32.

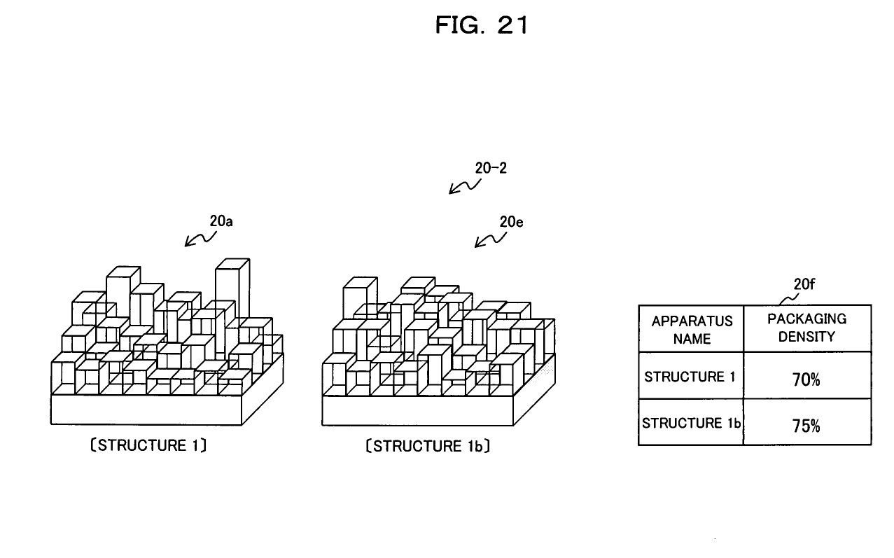

Concretely, in the case of a comparison between densities of a plurality of structures for density verification, for facilitating the density comparison by the operator, for example, as shown in FIG. 21, the display control unit 20 makes the display unit 32 display, as a display screen 20-2, densities of a plurality of structures 1 and 1b, bar graphs 20a and 20e corresponding to the densities of the plurality of structures 1 and 1b and a table 20f having numeric values (in this case, Apparatus Name and Packaging Density (%)) corresponding to the bar graphs 20a and 20e.

That is, the calculation area setting unit 15 of the calculation method setting unit 13 of this design supporting apparatus 10 is made to set calculation areas with respect to the plurality of structures 1 and 1b in accordance with an instruction from the operator and, when the calculation area setting unit 15 sets the calculation areas with respect to the plurality of structures 1 and 1b and the density calculating unit 18 calculates the densities of the plurality of structures 1 and 1b, the display control unit 20 displays the densities of the plurality of structures 1 and 1b simultaneously on the display unit 32.

Accordingly, the operator can make a comparison between the densities of the plurality of structures 1 and 1b by taking one look at the display unit 32, thereby achieving easy and reliable comparison in density between the plurality of structures 1 and 1b.

Moreover, by making a comparison on the bar graphs 20a and 20e indicating a density distribution, the operator can recognize density ununiformity, room and others of each of the plurality of structures at a glance, which enables more detailed comparison verification.

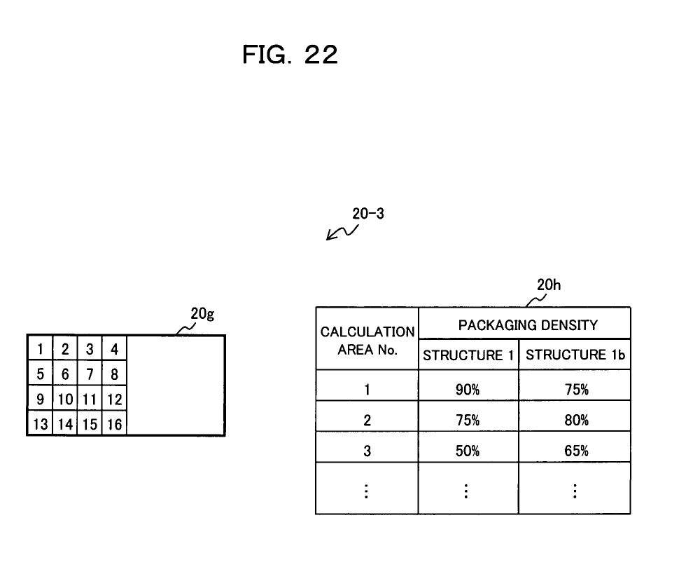

In this connection, it is also appropriate that, for example, as shown in FIG. 22, without using bar graphs, the display control unit 20 makes the display unit display a display screen 20-3 composed of a FIG. 20g indicative of calculation areas (concretely, calculation area No.) and a table 20h indicating the densities of the respective calculation areas.

Still moreover, it is also appropriate that, on the basis of a density of a different structure 1b held in advance or a density of the different structure 1b inputted to the display control unit 20, the display control unit 20 makes the display unit 32 simultaneously display the densities of the plurality of structures 1 and 1b as shown in FIGS. 21 and 22.

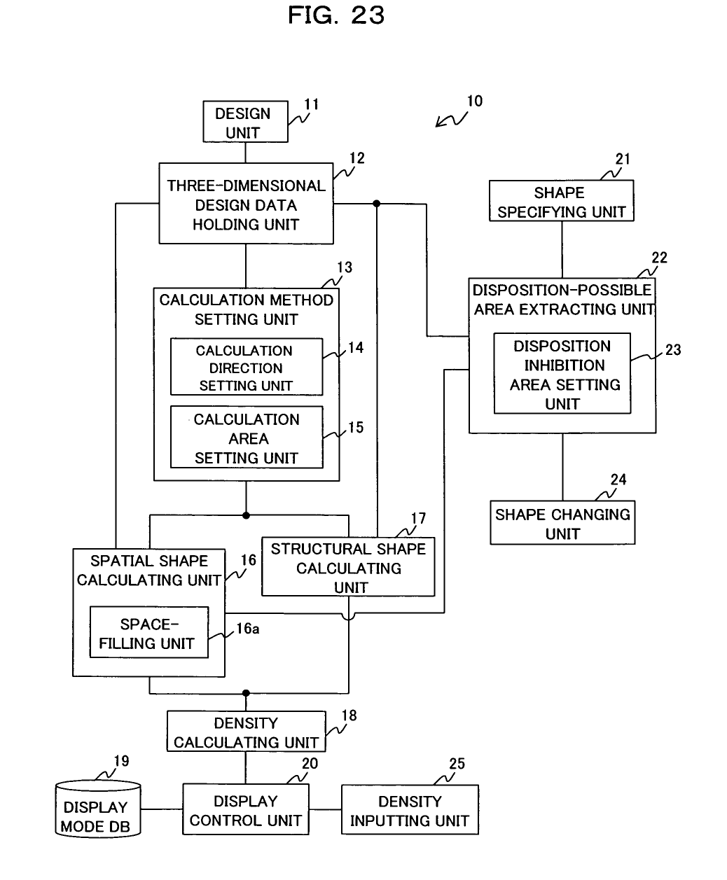

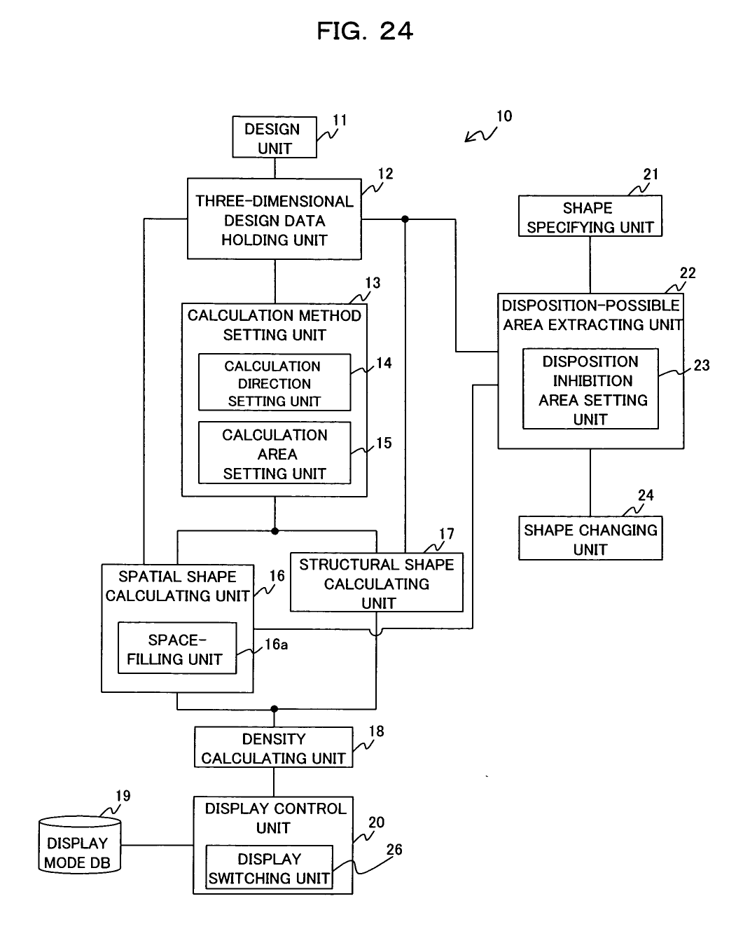

That is, as shown in FIG. 23, the design supporting apparatus 10 can include a density inputting unit 25 for inputting a density previously calculated by the density calculating unit 18 or a density obtained in the external and, in this case, the display control unit 20 makes the display unit 32 simultaneously display a density of the structure 1 calculated by the density calculating unit 18 and a density of the structure 1b inputted through the density inputting unit 25. In FIGS. 23 and 24, the same reference numerals as those used above designate the same or almost same parts, and the detailed description thereof will be omitted for brevity.

Accordingly, for example, when the density inputting unit 25 inputs, to the display control unit 20, a density of the same structure 1, before design change, as the structure undergoing the density calculation by the density calculating unit 18, the operator can easily make a comparison between the densities of the structure 1 before and after the design change, and the convenience is improvable to the operator.

In addition, although in the above description of the embodiment the display control unit 20 displays a density on the display unit 32 on the basis of one format with respect to one result (density), the present invention is not limited to this, but it is also appropriate that, for example, as shown in FIG. 24, the display control unit 20 includes a display switching unit 26 for switching the display format for the density displayed on the display unit 32 according to a format held in the display mode database 19. This can further improve the operator's convenience.

The above-described functions as the design unit 11, the calculation method setting unit 13, the calculation direction setting unit 14, the calculation area setting unit 15, the spatial shape calculating unit 16, the space-filling unit 16a, the structural shape calculating unit 17, the density calculating unit 18, the display control unit 20, the shape specifying unit 21, the disposition-possible area extracting unit 22, the disposition inhibition area setting unit 23, the shape changing unit 24, the density inputting unit 25 and the display switching unit 26 are realizable in a manner such that a computer (including CPU, information processing apparatus and various types of terminals) executes a predetermined application program (design supporting program).

This program is offered, for example, in a state recorded in a computer-readable recording medium such as flexible disk, CD (CD-ROM, CD-R, CD-RW or the like) or DVD (DVD-ROM, DVD-RAM, DVD-R, DVD-RW, DVD+R, DVD+RW or the like). In this case, the computer reads out the design supporting program from this recording medium and transfers it to an internal storage unit or an external storage unit to store therein for use. It is also appropriate that this program is recorded in, for example, a storage unit (recording medium) such as magnetic disk, optical disk or magneto optical disk and offered from the storage unit through a communication line to the computer.

In this case, the computer signifies the concept including hardware and OS (Operating System) and means the hardware operating under control of the OS. Moreover, in a case in which the OS is unnecessary and the application program itself operates the hardware, the hardware itself corresponds to the computer. The hardware includes at least a microprocessor such as a CPU and a means for reading out a computer program recorded in a recording medium.

The application program serving as the aforesaid design supporting program includes a program code for making the computer realize the functions as the design unit 11, the calculation method setting unit 13, the calculation direction setting unit 14, the calculation area setting unit 15, the spatial shape calculating unit 16, the space-filling unit 16a, the structural shape calculating unit 17, the density calculating unit 18, the display control unit 20, the shape specifying unit 21, the disposition-possible area extracting unit 22, the disposition inhibition area setting unit 23, the shape changing unit 24, the density inputting unit 25 and the display switching unit 26. Moreover, a portion of the functions can also be realized by the OS instead of the application program.

As the recording medium in this embodiment, in addition to the above-mentioned flexible disk, CD, DVD, magnetic disk, optical disk and magneto optical disk, various types of computer-readable mediums are also available which includes IC card, ROM cartridge, magnetic tape, punch card, internal storage unit (memory such as RAM or ROM) of a computer, external storage unit and further includes printed matter, such as bar code, on which a code is printed.

What is claimed is:

1. A design supporting apparatus comprising:
a spatial shape calculating unit for calculating a spatial shape within a predetermined area of a structure on the basis of three-dimensional design data on said structure;
a structural shape calculating unit for calculating a structural shape within the predetermined area of the structure on the basis of the three-dimensional design data;
a density calculating unit for calculating a structural density or a spatial density within the predetermined area of the structure on the basis of the spatial shape calculated by said spatial shape calculating unit and the structural shape calculated by said structural shape calculating unit; and
a display control unit for making a display unit display the structural density or spatial density calculated by said density calculating unit.

2. The design supporting apparatus according to claim 1, further comprising a calculation direction setting unit for setting a calculation direction of the structural density or the spatial density to be calculated by said density calculating unit;
said density calculating unit calculating the structural density or the spatial density on the basis of the calculation direction set by said calculation direction setting unit.

3. The design supporting apparatus according to claim 1, further comprising a calculation area setting unit for setting one or more calculation areas as the predetermined area of the structure;
said density calculating unit calculating the structural density or the spatial density of the calculation area set by said calculation area setting unit.

4. The design supporting apparatus according to claim 3, wherein said spatial shape calculating unit and said structural shape calculating unit calculate the spatial shape and the structural shape, respectively, with respect to the calculation area set by said calculation area setting unit.

5. The design supporting apparatus according to claim 1, wherein, with respect to a component having a disposition-impossible space within the predetermined area of the structure, said spatial shape calculating unit calculates the spatial shape on the assumption that said disposition-impossible space is nonexistent.

6. The design supporting apparatus according to claim 1, wherein, when said density calculating unit calculates a plurality of structural densities or spatial densities of the structure, said display control unit makes said display unit simultaneously display the plurality of structural densities or spatial densities calculated by the density calculating unit.

7. The design supporting apparatus according to claim 1, wherein said display control unit makes said display unit display a density distribution of the structure on the basis of the structural density or the spatial density calculated by said density calculating unit.

8. The design supporting apparatus according to claim 1, further comprising an extracting unit for extracting a disposition-possible area, where a disposition of a desired part is possible, from the spatial shape calculated by said spatial shape calculating unit, on the basis of a shape of the desired part.

9. The design supporting apparatus according to claim 8, further comprising a disposition inhibition area setting unit for setting, in the spatial shape, a disposition inhibition area where the disposition of the desired part is inhibited;
said extracting unit extracts the disposition-possible area according to the disposition inhibition area set by said disposition inhibition area setting unit.

10. The design supporting apparatus according to claim 8, further comprising a shape changing unit for changing the shape of the desired part on the basis of the disposition-possible area extracted by said extracting unit.

11. The design supporting apparatus according to claim 8, wherein, when an existing part previously provided within the predetermined area is set as the desired part, said spatial shape calculating unit sets an area, where said existing part lies, as being included in the spatial shape.

12. A design supporting method comprising:
a spatial shape calculating step of calculating a spatial shape within a predetermined area of a structure on the basis of three-dimensional design data on said structure;
a structural shape calculating step of calculating a structural shape within the predetermined area of the structure on the basis of the three-dimensional design data;
a density calculating step of calculating a structural density or a spatial density within the predetermined area of said structure on the basis of the spatial shape calculated in said spatial shape calculating step and the structural shape calculated in said structural shape calculating step; and
a display control step of making a display unit display the structural density or the spatial density calculated in said density calculating step.

13. The design supporting method according to claim 12, further comprising a calculation direction setting step of setting a calculation direction of the structural density or the spatial density to be calculated in said density calculating step;
said density calculating step calculating the structural density or the spatial density on the basis of the calculation direction set by said calculation direction setting step.

14. The design supporting method according to claim 12, further comprising a calculation area setting step of setting one or more calculation areas as the predetermined area of the structure;
said density calculating step calculating the structural density or the spatial density of the calculation area set in said calculation area setting step.

15. The design supporting method according to claim 14, wherein, in said spatial shape calculating step and said structural shape calculating step, the spatial shape and the structural shape are calculated with respect to the calculation area set in said calculation area setting step.

16. The design supporting method according to claim 12, further comprising an extracting step of extracting a disposition-possible area, where a disposition of a desired part is possible, from the spatial shape calculated in said spatial shape calculating step, on the basis of a shape of the desired part.

17. A computer-readable recording medium recording a design supporting program for making a computer realize a function to execute a support for a design of a structure, said design supporting program making said computer function as:
a spatial shape calculating unit for calculating a spatial shape within a predetermined area of a structure on the basis of three-dimensional design data on said structure;
a structural shape calculating unit for calculating a structural shape within the predetermined area of the structure on the basis of the three-dimensional design data;
a density calculating unit for calculating a structural density or a spatial density within the predetermined area of the structure on the basis of the spatial shape calculated by said spatial shape calculating unit and the structural shape calculated by said structural shape calculating unit; and
a display control unit for making a display unit display the structural density or the spatial density calculated by said density calculating unit

18. The computer-readable recording medium recording a design supporting program according to claim 17, wherein said design supporting program makes said computer further function as a calculation direction setting unit for setting a calculation direction of the structural density or the spatial density to be calculated by said density calculating unit;
said density calculating unit calculating the structural density or the spatial density on the basis of the calculation direction set by said calculation direction setting unit.

19. The computer-readable recording medium recording a design supporting program according to claim 17, wherein said design supporting program makes said computer further function as a calculation area setting unit for setting one or more calculation areas as the predetermined area of the structure;
said density calculating unit calculates the structural density or the spatial density of the calculation area set by said calculation area setting unit.

20. The computer-readable recording medium recording a design supporting program according to claim 17, wherein said design supporting program makes said computer further function as an extracting unit for extracting a disposition-possible area, where a disposition of a desired part is possible, from the spatial shape calculated by said spatial shape calculating unit, on the basis of a shape of the desired part.
